(19) United States
(12) Patent Application Publication
(10) Pub. No.: US 2013/0079182 A1
(43) Pub. Date: Mar. 28, 2013

(54) PULLEY SYSTEM FOR OUTDOOR POWER EQUIPMENT

(71) Applicant: Briggs & Stratton Corporation, Wauwatosa, WI (US)

(72) Inventors: Jason J. Raasch, Cedarburg, WI (US); Richard J. Gilpatrick, Whitewater, WI (US)

(73) Assignee: Briggs & Stratton Corporation, Wauwatosa, WI (US)

(21) Appl. No.: 13/624,770

(22) Filed: Sep. 21, 2012

Related U.S. Application Data
(60) Provisional application No. 61/538,714, filed on Sep. 23, 2011.

(51) Int. Cl. F16H 55/52; B21K 1/42; F16H 55/36

(52) U.S. Cl. 474/8; 474/174; 29/892.11

(57) ABSTRACT

A method of manufacturing a pulley system includes spin-forming metal to form an annular wall of a sheave, pressing powdered metal to form a hub of the sheave, and fastening together the annular wall and the hub.

### CROSS-REFERENCE TO RELATED PATENT APPLICATIONS

This application claims the benefit of Application No. 61/538,714, filed Sep. 23, 2011, which is incorporated herein by reference in its entirety.

### BACKGROUND

The present disclosure relates to a pulley system. More particularly, the present disclosure relates to a pulley system including one or more sheaves configured for use as part of a continuously variable transmission of outdoor power equipment, such as a snow thrower, a portable generator, a rotary tiller, or another form of outdoor power equipment.

### SUMMARY

One embodiment of the invention relates to a pulley system configured for use as part of a continuously variable transmission of outdoor power equipment. The pulley system includes a sheave having a hub formed from a first material, a first annular wall formed from a second material, wherein the first annular wall includes a guide surface and is fastened to the hub, and a second annular wall including a guide surface, wherein the guide surface of the first annular wall faces the guide surface of the second annular wall to provide a track configured to receive a belt.

Another embodiment of the invention relates to a method of manufacturing a pulley system including the steps of spin-forming metal to form an annular wall of a sheave, pressing powdered metal to form a hub of the sheave, and fastening together the annular wall and the hub.

Another embodiment of the invention relates to outdoor power equipment including an engine having a crankshaft having a power takeoff, a tool having a driveshaft and configured to be powered by the engine, and a pulley system coupling the engine and the tool. The pulley system includes a first sheave having a first hub including an aperture configured to receive the power takeoff, a first annular wall fastened to the first hub, wherein the first annular wall includes a guide surface, and a second annular wall including a guide surface, wherein the second annular wall is fastened to the power takeoff of the crankshaft of the engine, and wherein the guide surface of the first annular wall faces the guide surface of the second annular wall to provide a first track configured to receive a belt.

Alternative exemplary embodiments relate to other features and combinations of features as may be generally recited in the claims.

### BRIEF DESCRIPTION OF THE FIGURES

The invention will become more fully understood from the following detailed description, taken in conjunction with the accompanying drawings, wherein like reference numerals refer to like elements, in which:

FIG. 1 is a perspective view of a snow thrower according to an exemplary embodiment of the invention.

FIG. 2 is a sectional view of an engine according to an exemplary embodiment of the invention.

FIG. 3 is a schematic diagram of a lawn mower system according to an exemplary embodiment of the invention.

FIG. 4 is a schematic diagram of a rotary tiller system according to an exemplary embodiment of the invention.

FIG. 5 is a sectional view of a secondary sheave of a pulley system according to an exemplary embodiment of the invention.

FIG. 6 is a sectional view of a primary sheave of the pulley system of FIG. 5.

FIG. 7 is a perspective sectional view of a secondary sheave of the pulley system of FIG. 5.

FIG. 8 is a sectional view of the secondary sheave of FIG. 7.

FIG. 9 is a perspective view of a secondary hub of the pulley system of FIG. 5.

FIG. 10 is a perspective view of a primary hub of the pulley system of FIG. 5.

FIG. 11 is a sectional view of a primary sheave of a pulley system according to another exemplary embodiment of the invention.

FIG. 12 is a sectional view of a secondary sheave of the pulley system of FIG. 11.

The skilled artisan will understand that the drawings primarily are for illustrative purposes and are not intended to limit the scope of the inventive subject matter described herein.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

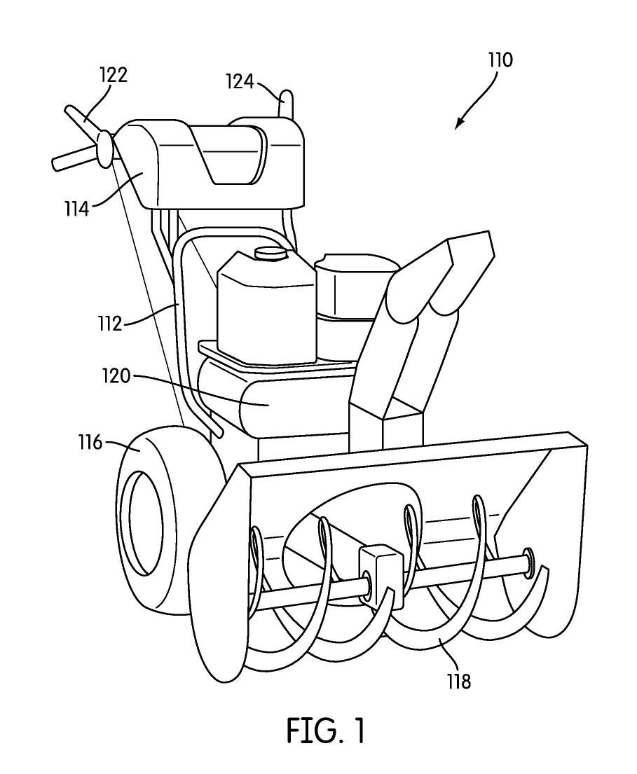

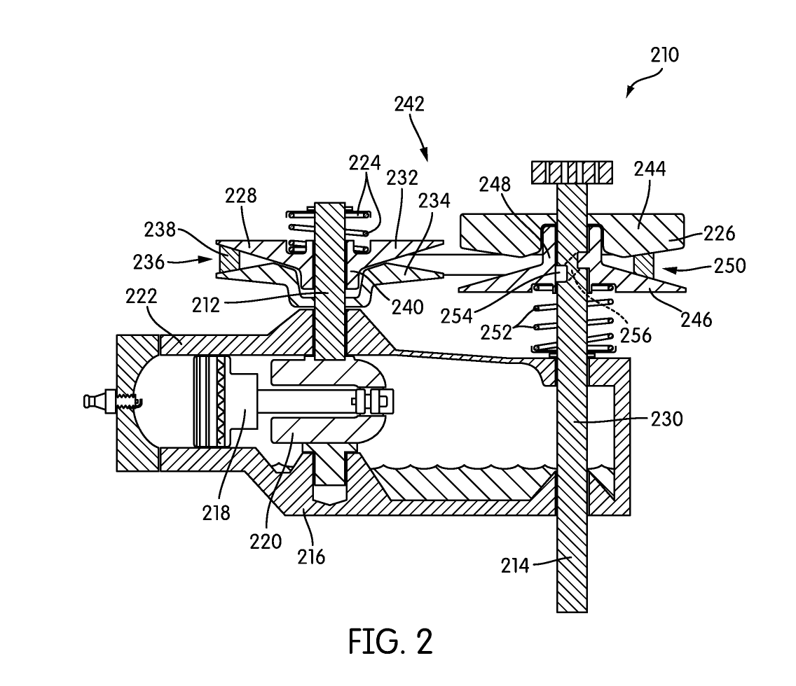

Referring to FIG. 1, outdoor power equipment in the form of a snow thrower 110 includes a frame 112 with a handle 114 and wheels 116, an engine 120 supported by the frame 112, and a tool in the form of an auger 118. According to an exemplary embodiment, an operator may control the snow thrower 110 from levers 122, 124 extending from the handle 114. One lever 122 may correspond to the drive train of the snow thrower 110 while the other lever 124 may actuate the auger 118. When engaged, the engine 120 powers the auger 118 via a power takeoff (see, e.g., power takeoffs 212, 214 as shown in FIG. 2) of the engine 120 coupled to a driveshaft 126 of the auger by way of a pulley system (see, e.g., pulley system 210 as shown in FIG. 2).

Referring to FIG. 2, an engine 210 includes an engine block 216 (e.g., crankcase) that supports a piston 218 and a crankshaft 220. Combustion processes in a cylinder portion 222 of the engine block 216 drive the piston 218 to rotate the crankshaft 220. According to an exemplary embodiment, the crankshaft 220 extends from the engine block 216 and a power takeoff 212 of the crankshaft 220 engages a pulley system 224. In some embodiments, the pulley system 224 is at least part of a transmission, such as a continuously variable transmission or other transmission, between the engine 210 and a tool (e.g., generator rotor, riding mower drivetrain, lawn mower blade, etc.) driven by the engine 210.

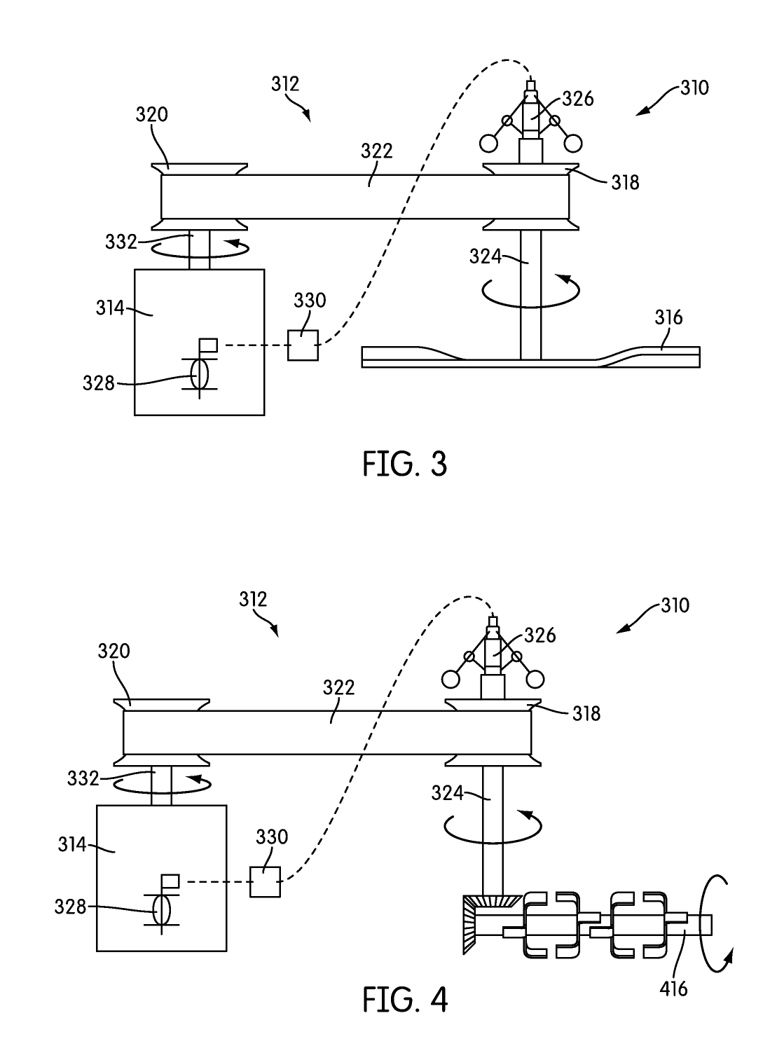

In some embodiments, the pulley system 224 is integrated with the engine 210, as shown in FIG. 2, such that a secondary sheave 226 (e.g., pulley wheel), a primary sheave 228, a driving shaft (e.g., crankshaft 220), and a driven shaft (e.g., driveshaft 230 of the tool) are all supported by and integrated with the engine 210. In other embodiments, a pulley system is coupled to the engine, but one of the primary or secondary sheaves and one of the driving or driven shafts are physically separated from the engine by an intermediate structure (e.g., frame 112 as shown in FIG. 1) and connected to the other of the primary or secondary sheaves and the other of the driving or driven shafts by a belt (see generally FIGS. 3-4).

According to an exemplary embodiment, the primary sheave 228 is coupled to the power takeoff 212 of the crankshaft 220. The primary sheave 228 includes two annular walls 232, 234 that are configured to move closer together or further apart from one another in order to adjust the width of a track 236 between the two annular walls 232, 234. Adjustment of the width of the track 236 causes a belt 238 joining the primary sheave 228 to the secondary sheave 226 to move closer or further from the axis of rotation of the primary sheave 228, and to thereby change the gear ratio of the pulley system 224. In some embodiments, one of the annular walls 232, 234 is fixed to a hub 240 that is configured to move axially with respect to the power takeoff 212 of the crankshaft 220. A spring 242 biases the annular walls 232, 234 together and tension in the belt 238 may overcome the bias of the spring 242.

In some embodiments, tension in the belt 238 is controlled by the secondary sheave 226. In other embodiments, a separate tensioning arm may be used to control tension in the belt. In some embodiments, the secondary sheave is coupled to the power takeoff of the crankshaft of the engine, and the primary sheave is coupled to the tool. In still other contemplated embodiments, one or both of the sheaves have fixed track widths and the annular walls of the sheaves are not configured to move relative to one another. In some such cases, the sheaves may serve as sheaves of a traditional pulley system, as opposed to a continuously variable transmission.

According to an exemplary embodiment, the secondary sheave 226 is coupled to a driven shaft (e.g., driveshaft 230) that may be coupled to a tool, such as a driveshaft of an auger on a snow thrower, a lawn mower blade, tines of a rotary tiller, or another tool. Similar to the primary sheave 228, the secondary sheave 226 includes a first annular wall 244, a second annular wall 246, and a hub 248. One of the annular walls 244, 246 is fixed to the hub 248, and the hub 248 is configured to move along the driveshaft 230 of the tool to change the track width 250 of the primary sheave 226.

A spring 252 biases the first and second annular walls 244, 246 together, and a change in torque on the driveshaft 230 causes rollers 254 coupled to the second annular wall 246 to rotate with respect to a spiral groove 256 that guides movement of the first and second annular walls 244, 246 closer together or further apart. Movement of the annular walls 244, 246 changes tension in the belt 238, which is communicated to the primary sheave 228.

Referring to FIGS. 3-4, outdoor power equipment 310 includes a pulley system 312. An engine 314 is connected to powered tools in the form of a lawn mower blade 316 (FIG. 3) and tines 416 of a rotary tiller (FIG. 4) by way of the pulley system 312. According to some exemplary embodiments, the pulley system 312 includes a secondary sheave 318 coupled to a primary sheave 320 by way of a belt 322. In some embodiments, one or both of the sheaves 318, 320 are configured to have variable track widths such that the pulley system 312 may serve as a continuously variable transmission between the engine 314 and the powered tool.

According to some exemplary embodiments, the secondary sheave 318 of the pulley system 312 is coupled to a driveshaft 324 of the powered tool along with a governor 326 (e.g., mechanical governor, electronic governor, rotational accelerometer, pneumatic governor in communication with a blower fan). The governor 326 provides feedback to a throttle system 328 of the engine 314, such as by way of an electronic control unit 330, which may adjust the speed of the engine 314 as a function of the rotation rate of the driveshaft 324, as opposed to the crankshaft 332. In some such embodiments, changes in torque experienced by the driveshaft 324 control the secondary sheave 318, which controls the gear ratio of the pulley system 312. In other embodiments, the only governor of the system is connected to the crankshaft, the secondary sheave is fastened to the crankshaft, one of the sheaves has a fixed track width and a tensioning arm is used to control tension in the belt, or other configurations of a pulley system may be used.

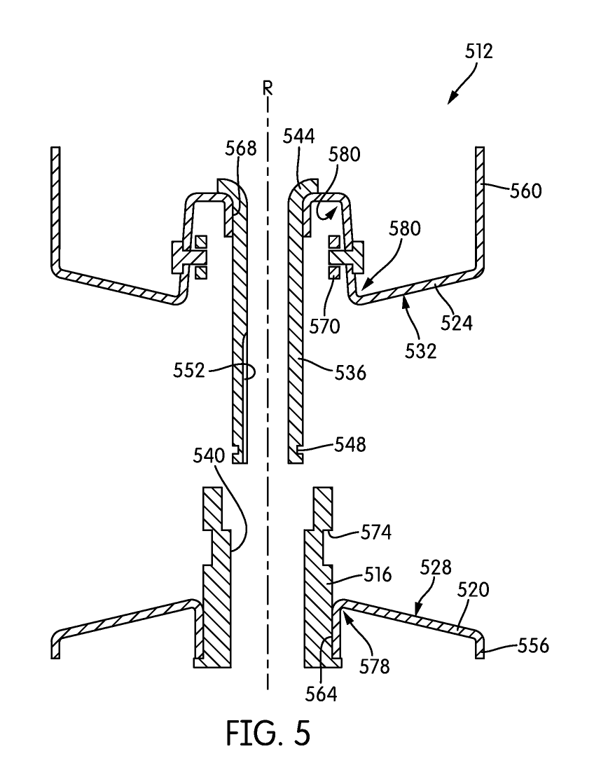

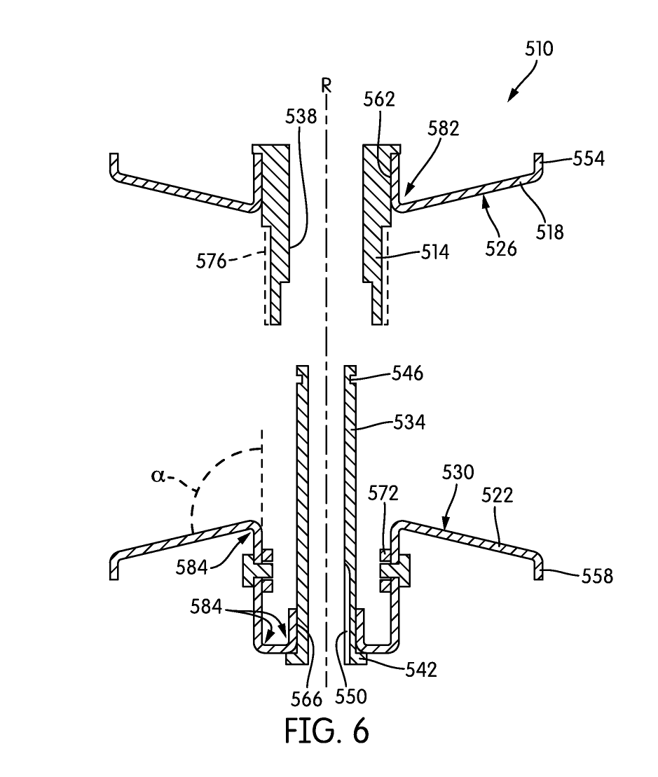

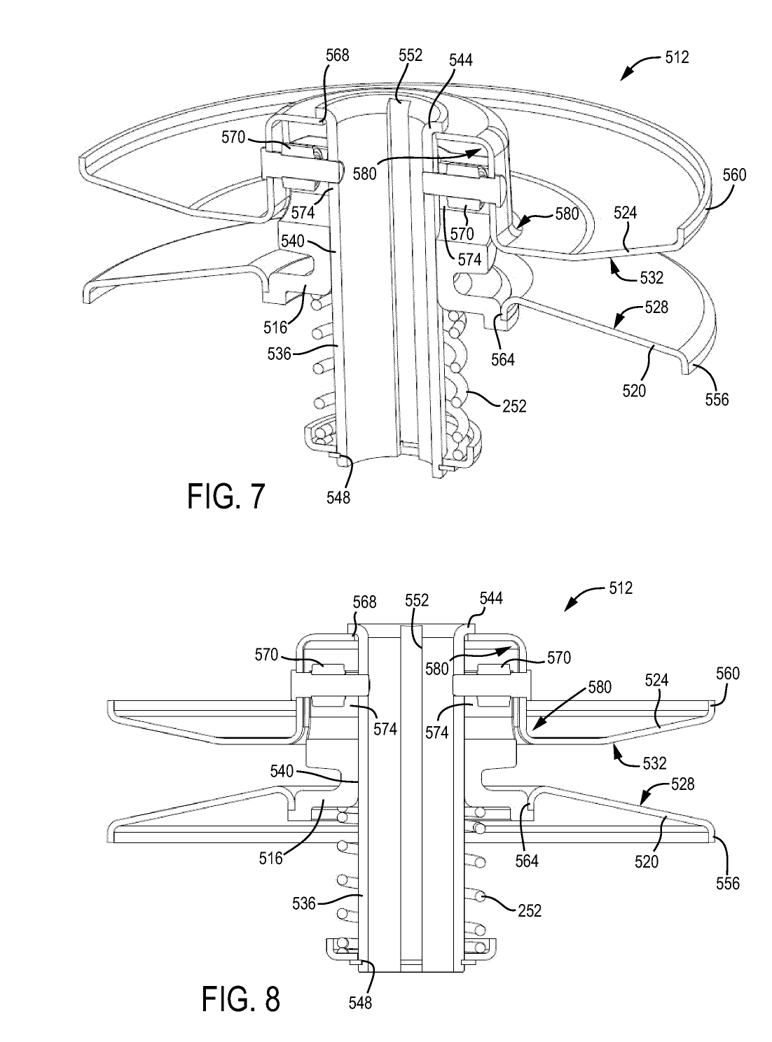

Referring now to FIGS. 5-8, a pulley system includes a primary sheave 510 (FIG. 6) and a secondary sheave 512 (FIGS. 5 and 7-8), and the pulley system is configured for use as part of a continuously variable transmission of outdoor power equipment. According to an exemplary embodiment, each sheave 510, 512 includes a hub 514, 516, a first annular wall 518, 520, and a second annular wall 522, 524. The first and second annular walls 518, 520, 522, 524 of each sheave 510, 512 include respective guide surfaces 526, 528, 530, 532 that face one another to define a track of the respective sheave 510, 512 that is configured to receive a belt of the pulley system (see, e.g., tracks 236, 250 and belt 238 as shown in FIG. 2).

According to an exemplary embodiment, one of the first and second annular walls 518, 520, 522, 524 is fastened to the hub 514, 516 of the respective sheave 510, 512. The other of the first and second annular walls 518, 520, 522, 524 is fastened to a shaft 534, 536 (e.g., power takeoff, driveshaft, tube coupled to a power takeoff or driveshaft) that is inserted through an aperture 538, 540 in the respective hub 514, 516 such that the hub 514, 516 is configured to move axially along the shaft 534, 536. Movement of the hub 514, 516 along the shaft 534, 536 changes the track width of the respective sheave 510, 512.

Referring to FIGS. 5-8, the shaft 534, 536 is formed from a piece of tube stock (e.g., seamless hydraulic tube stock blanks, steel tube stock, aluminum tube stock). One end 542, 544 of the tube stock is flared to provide a constraint limiting movement of the corresponding annular wall 518, 524 fastened to the tube stock. A radial groove 546, 548 is cut proximate to the other end of the tube stock, which is configured to receive a snap ring for a spring retainer of the sheave 510, 512, which biases the guide surfaces 526, 528, 530, 532 of the annular walls 518, 520, 522, 524 together (see, e.g., springs 242, 252 as shown in FIG. 2). Additionally, a keyway 550, 552 is cut into the tube stock, which is configured to receive a keyed power takeoff of an engine or driveshaft of a powered tool (see, power takeoffs 212, 214 as shown in FIG. 2). The keyways 550, 552 may be cut into opposite ends of the tube stocks of the primary and secondary sheaves 510, 512, as shown in FIGS. 5-8. In some embodiments, grooves of a spline may be rolled into the tube stock to secure the interface of the tube stock with the respective annular wall 522, 524.

In some embodiments, the annular walls 518, 520, 522, 524 include an inner aperture 562, 564, 566, 568. The inner aperture 562, 564, 566, 568 is centered in the middle of the guide surface 526, 528, 530, 532 of the respective annular wall 518, 520, 522, 524 and is configured to receive either the hub 514, 516 or the shaft 534, 536, 634, 636. In some embodiments, the inner aperture 562, 564, 566, 568 includes a side wall that extends in the direction of the axis of rotation R and is configured to interface with the exterior surface of the hub 514, 516 or the shaft 534, 536, 634, 636. In other embodiments, the annular wall 518, 520, 522, 524 attaches to the lengthwise end of the hub 514, 516 or shaft 534, 536, 634, 636 instead of extending along the exterior surface of the hub 514, 516 or shaft 534, 536, 634, 636.

According to an exemplary embodiment, the guide surface 526, 528, 530, 532 extends away from the respective hub 514, 516 or shaft 534, 536, 634, 636 at an angle α that is wider than a right angle such that the opposing guide surfaces 526, 528, 530, 532 form sides of a V-shaped track when the annular walls 518, 520, 522, 524 of the respective sheaves 510, 512 are close to one another. Put another way, the guide surfaces 526, 528, 530, 532 define angled sides of a trapezoid where the wider base of the trapezoid is further from the axis of rotation R, as shown in FIGS. 5-6.

According to an exemplary embodiment, the annular walls 518, 520, 522, 524 further include an outer lip 554, 556, 558, 560 (e.g., outer diameter) or flange that is angled with respect to the guide surface 526, 528, 530, 532 and extends away from the other of the first or second annular wall 518, 520, 522, 524. Roll grooves may be pressed or stamped into the outer lip 554, 556, 558, 560 of the annular walls 518, 520, 522, 524 or elsewhere on the annular walls 518, 520, 522, 524 for increased strength and stiffening.

In some embodiments, the outer lip 560 is long enough to hold considerable mass, and serves as an inertia ring or flywheel. In some such embodiments, at least a quarter of the mass of the annular wall 524 is located in the outer lip 560, such as at least a third or at least half of the mass. In other embodiments, a cast ring may be pressed onto the annular wall, forming a T-shaped flange on the outer edge of the annular wall to serve as an inertia ring. Use of an inertia ring or flywheel is intended to dampen out load transitions in the pulley system.

In contemplated embodiments, the inertia ring, annular wall, and tube are integrally formed together via a casting, such as with a solid iron casting. In other contemplated embodiments, the inertia ring, annular wall, and tube may be integrally formed via metal spinning.

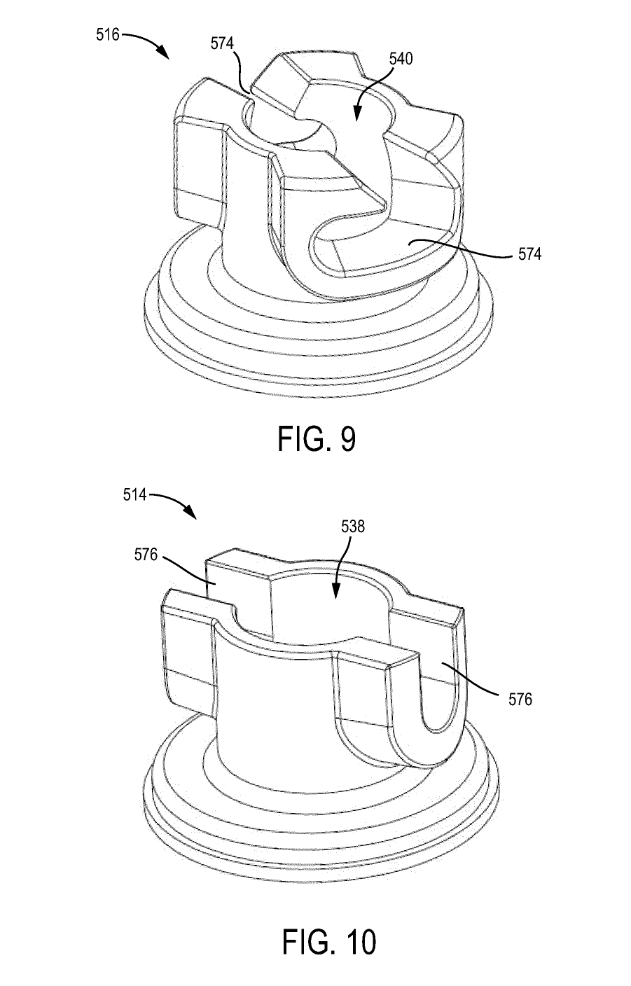

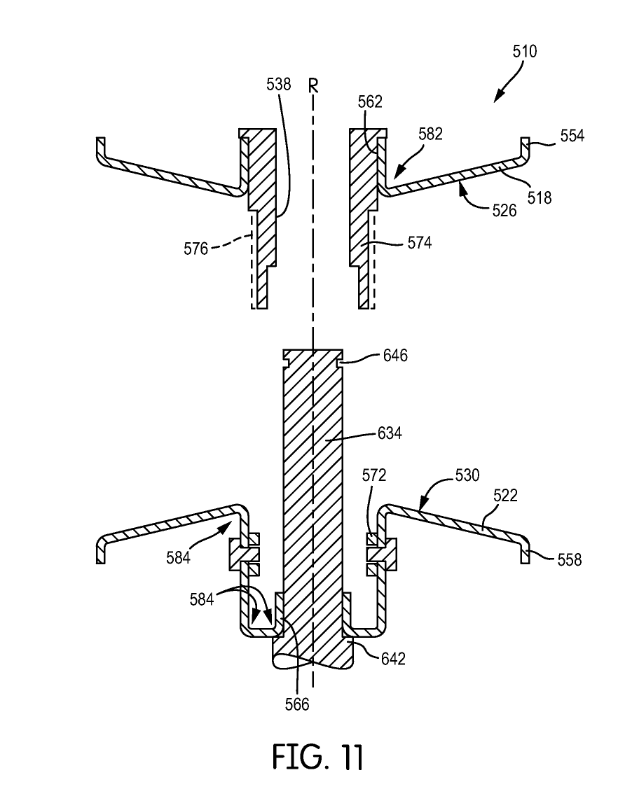

In some embodiments, one of the annular walls 518, 520 is fastened to the hub 514, 516 and the other of the annular walls 522, 524 includes a guide element, such as a roller 570, 572, bearing, extension, etc., that is sized to be received in a groove 574, 576 or slot on the outer surface of the hub 514, 516. The roller 570, 572 and groove 574, 576 constrain movement of the annular walls 518, 520, 522, 524 relative to one another. According to an exemplary embodiment, as shown in FIG. 9, the groove 574 of the hub 516 of the secondary sheave 512 is helical about the hub 516 such that the annular walls 520, 524 turn relative to each other as the guide surfaces 528, 532 of the annular walls 520, 524 move closer together or further apart. In some such embodiments, as shown in FIG. 10, the grooves 576 of the hub 514 of the primary sheave 510 are straight and extend axially along the hub 514.

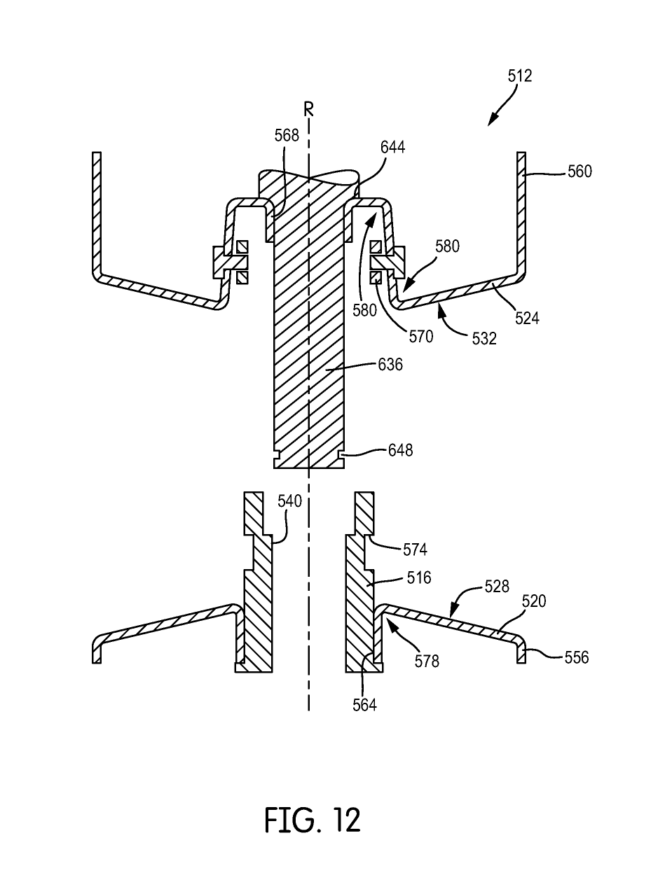

Referring to FIGS. 11-12, shafts 634, 636 are extensions or portions of the power takeoff of a crankshaft or driveshaft of a powered tool (see, generally FIGS. 1-4). Use of direct extensions or integral portions of the power takeoff and driveshaft removes the need for a separate tube coupled to the power takeoff or driveshaft. Eliminating the separate tube reduces the number of parts and may provide for a more compact design of the corresponding engine or outdoor power equipment (see, generally FIGS. 1-2). The shafts 634, 636 include a flared end 642, 644 against which one of the annular walls 518, 520 is fastened. The opposite end of the shaft 634, 636 includes a radial groove 646, 648 configured to receive a snap ring. As illustrated, the annular walls 518, 520 including the rollers 570, 572 are fastened to the shafts 634, 636 with the hubs 514, 516 and the other of the annular walls 518, 520 movable along the shafts 634, 636. However, in other embodiments, the hubs 514, 516 are fastened to the shafts 634, 636 with one of the annular walls 518, 520 fastened to the hubs 514, 516 and the other of the annular walls 518, 520 movable along the shafts 634, 636.

According to an exemplary embodiment, the hub 514, 516 and at least one of the annular walls 518, 520, 522, 524 are formed separately from one another and are subsequently fastened together. The different processes used to form the hub 514, 516 and annular walls 518, 520, 522, 524, such as powdered-metal pressing and metal spinning, may be particularly efficient for manufacturing the respective parts, especially when compared to the costly and intensive process of die casting and machining pulley sheaves formed as integral wall-and-hub structures. Die casting sheaves for a pulley system may require that a manufacturer invest in costly die cast tooling. In addition, the casting must be machined in order to improve the surface finish and reduce run-out. The added machining steps increase the costs of the parts in terms of labor and resources. Using the different methods of forming individual components of the sheaves 510, 512 and subsequently fastening them together may remove some of the costly process steps. However, in other contemplated embodiments die casting and machining may be used.

According to an exemplary embodiment, one or both of the annular walls 518, 520, 522, 524 are formed via metal spinning (e.g., spin forming, spinning) where the metal (e.g., blank steel or aluminum) is rotated, such as on a lathe, and formed into an axially-symmetric annular wall. Spinning metal to form the annular walls 518, 520, 522, 524 is believed to provide improved concentricity to the resulting annular walls 518, 520, 522, 524, relative to other processes such as stamping or molding. Improved concentricity reduces wobble of the sheaves 510, 512 in the pulley system and correspondingly reduces noise and vibration-related wear of the outdoor power equipment.

In other embodiments, one or both of the annular walls 518, 520, 522, 524 are stamped from sheet metal, such as sheets of aluminum, steel, or other metals. Some such annular walls 518, 520, 522, 524 are formed from sheets of substantially uniform thickness. If stamped, the center part of the annular wall 518, 520, 522, 524 may be formed as a bubble that is subsequently pierced to form the aperture 562, 564, 566, 568 and then coined. Alternatively or in addition to stamping the annular walls 518, 520, 522, 524, gussets may be stamped into the inner bends 578, 580, 582, 584 opposite to the guide surface 526, 528, 530, 532 for reinforcement of the sheaves 510, 512 out of the way of the belt.

In still other embodiments, one or both of the annular walls 518, 520, 522, 524 are formed from molded plastic, such as injection molded low-density polyethylene, acrylonitrile butadiene styrene, polycarbonate/acrylonitrile butadiene styrene blend, polyetheretherketone, or other plastics. In some contemplated embodiments, a support frame (e.g., “backbone”) of metal may be stamped and then set and molded into a plastic-molded annular wall.

In some embodiments, the hub 514, 516 is formed from a process that is different than the process used to form one or both of the first and second annular walls 518, 520, 522, 524. According to an exemplary embodiment, the hub 514, 516 is formed from powdered metal that is compressed and heated to form a solid body. In other embodiments, the hub 514, 516 may be formed via metal spinning or injection molding of plastic. Features of the hub 514, 516, such as the grooves 574, 576 guiding the rollers 570, 572, may be reinforced with steel or another metal. In other embodiments, the hub 514, 516 is integrally formed with one or both of the annular walls 518, 520, 522, 524. In some embodiments the second annular hub 522, 524 and shaft 534, 536 are integrally formed together via metal spinning.

The hub 514, 516 may be formed from a first material and one or both of the annular walls 518, 520, 522, 524 may be formed from a second material. The first and second materials may be chemically different (e.g., steel versus aluminum, plastic versus metal), or the first and second materials may be chemically the same but different with regard to structure, such as a sheet of steel versus powdered steel. In some embodiments, the helix side of the sheave 512, such as the hub 516, is formed from plastic, while the shaft 536 is metal. In some such embodiments, a metal sleeve may be added to the helix groove 574 of a plastic hub for reinforcement and control of wear. In other embodiments, the hub 516 is formed from powdered metal.

According to an exemplary embodiment, the first annular wall 518, 520 is fastened to (e.g., fixed with respect to, welded to, riveted to, pressure fit to) the hub 514, 516. The second annular wall 520, 522 is fastened to a shaft 534, 536, 634, 636. In various alternate embodiments, the annular walls 518, 520, 522, 524 and the respective hubs 514, 516 or shafts 534, 536, 634, 636 may be spin welded together, pressed together, friction welded together, laser welded together, or otherwise fastened together. In still other embodiments, the hubs 514, 516 or shafts 534, 536, 634, 636 may include grooves or ridges for a spline coupling with the respective annular wall 518, 520, 522, 524.

The construction and arrangements of the pulley system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A pulley system configured for use as part of a continuously variable transmission of outdoor power equipment, comprising:
a sheave, comprising:
a hub formed from a first material;
a first annular wall formed from a second material, wherein the first annular wall comprises a guide surface and is fastened to the hub; and
a second annular wall comprising a guide surface, wherein the guide surface of the first annular wall faces the guide surface of the second annular wall to provide a track configured to receive a belt.

2. The pulley system of claim 1, wherein the first annular wall is formed from sheet metal such that the first annular wall has a substantially uniform thickness.

3. The pulley system of claim 2, wherein the hub is formed from powdered metal.

4. The pulley system of claim 1, wherein the hub and the first annular wall are configured to move with respect to the second annular wall to change the width of the track.

5. The pulley system of claim 4, wherein the hub comprises a groove and wherein the pulley system further comprises a roller coupled to the second annular wall, wherein the roller is configured to move within the groove to constrain movement of the hub and the first annular wall relative to the second annular wall.

6. The pulley system of claim 1, wherein the second annular wall is fastened to a shaft extending through an aperture in the center of the hub, and wherein the hub is configured to move axially along the shaft.

7. The pulley system of claim 1, wherein an interior side of the first annular wall extends lengthwise along a portion of the hub.

8. The pulley system of claim 1, wherein the second annular wall includes an outer lip that extends away from the track, wherein the outer lip comprises at least a quarter of the mass of the second annular wall such that the outer lip serves as a flywheel.

9. A method of manufacturing a pulley system, comprising:
spin-forming metal to form an annular wall of a sheave;
pressing powdered metal to form a hub of the sheave; and
fastening together the annular wall and the hub.

10. The method of claim 9, further comprising spin-forming metal to form a second annular wall of the sheave.

11. The method of claim 10, further comprising fastening the second annular wall of the sheave to a shaft.

12. The method of claim 11, further comprising inserting the shaft into an aperture in the center of the hub, wherein the hub is configured to move axially along the shaft.

13. The method of claim 12, further comprising forming the shaft by steps comprising:
flaring an end of blank tube stock having two ends;
cutting a keyway in an interior of the tube stock; and
cutting a groove proximate to the other end of the tube stock, wherein the groove is configured to receive a snap ring for a spring retainer.

14. The method of claim 12, wherein the shaft is a power takeoff portion of a crankshaft of an engine.

15. Outdoor power equipment, comprising:
an engine comprising a crankshaft having a power takeoff;
a tool comprising a driveshaft and configured to be powered by the engine; and
a pulley system coupling the engine and the tool, wherein the pulley system comprises a first sheave, comprising:
a first hub comprising an aperture configured to receive the power takeoff;
a first annular wall fastened to the first hub, wherein the first annular wall comprises a guide surface; and
a second annular wall comprising a guide surface, wherein the second annular wall is fastened to the power takeoff of the crankshaft of the engine, and wherein the guide surface of the first annular wall faces the guide surface of the second annular wall to provide a first track configured to receive a belt.

16. The outdoor power equipment of claim 15, further comprising a continuously variable transmission comprising the pulley system, wherein the hub and the first annular wall are configured to move with respect to the second annular wall axially along the power takeoff to change the width of the track.

17. The outdoor power equipment of claim 15, wherein the pulley system further comprises:
a belt; and
a second sheave, comprising:
a second hub comprising an aperture configured to receive the driveshaft of the tool, wherein the second hub is configured to move axially along the driveshaft;
a third annular wall fastened to the second hub, wherein the third annular wall comprises a guide surface; and
a fourth annular wall comprising a guide surface, wherein the fourth annular wall is fastened to the driveshaft of the tool, and wherein the guide surface of the third annular wall faces the guide surface of the fourth annular wall to provide a second track configured to receive a belt.

18. The outdoor power equipment of claim 17, further comprising:
a first roller coupled to the second annular wall;
wherein the first hub comprises a first groove and wherein the first roller is configured to move within the first groove to constrain movement of the first hub and the first annular wall relative to the second annular wall.

19. The outdoor power equipment of claim 18, further comprising:
a second roller coupled to the fourth annular wall;
wherein the second hub comprises a second groove and wherein the second roller is configured to move within the second groove to constrain movement of the second hub and the third annular wall relative to the fourth annular wall.

20. The outdoor power equipment of claim 15, further comprising:
a first roller coupled to the second annular wall;
wherein the first hub comprises a first groove and wherein the first roller is configured to move within the first groove to constrain movement of the first hub and the first annular wall relative to the second annular wall.
